(19) United States
(12) Patent Application Publication
(10) Pub. No.: US 2025/0210251 A1
(43) Pub. Date: Jun. 26, 2025

(54) Inductor Component and Preparation Method Therefor

(71) Applicants: HUIZHOU POCO NEW INDUCTOR TECHNOLOGY CO., LTD., Huizhou (CN); HEYUAN POCO NEW MATERIAL CO., LTD., Heyuan (CN)

(72) Inventors: Xiongzhi Guo, Shenzhen (CN); Yunfan Zhang, Shenzhen (CN); Tao Luo, ShenZhen (CN); Zhida Liu, ShenZhen (CN)

(73) Assignees: HUIZHOU POCO NEW INDUCTOR TECHNOLOGY CO., LTD., Huizhou (CN); HEYUAN POCO NEW MATERIAL CO., LTD., Heyuan (CN)

(21) Appl. No.: 18/962,278

(22) Filed: Nov. 27, 2024

(30) Foreign Application Priority Data
Dec. 21, 2023 (CN) 202311777005.0

(51) Int. Cl. H01F 27/30; H01F 17/04; H01F 27/28; H01F 41/02; H01F 41/04

(52) U.S. Cl. CPC H01F 27/306; H01F 17/04; H01F 27/2847; H01F 41/0206; H01F 41/04

(57) ABSTRACT

An inductor component includes at least one conductive structure, a magnetic core, and a covering layer. Each conductive structure includes a conductive body and two conductive pins, the two conductive pins are spaced apart in a first direction, the first direction is an extension direction of the conductive body, and the two conductive pins extend in a second direction and are connected to the conductive body. The magnetic core is provided with at least two accommodating cavities. The two conductive pins are respectively inserted into accommodating cavities to connect the each conductive structure to the magnetic core, and the two conductive pins are in a one-to-one correspondence with the accommodating cavities. The covering layer is disposed on a side of the conductive body of the each conductive structure away from the two conductive pins and is configured to cover the each conductive structure.

### CROSS-REFERENCE TO RELATED APPLICATION(S)

This application claims priority to Chinese Patent Application No. 202311777005.0 filed Dec. 21, 2023, the disclosure of which is incorporated herein by reference in its entirety.

### TECHNICAL FIELD

The present invention relates to the field of electronic component technology, in particular, an inductor component and a preparation method thereof.

### BACKGROUND

As fundamental electronic components, inductor components are widely used. Inductor components mainly serve to filter signals, reduce noise, stabilize current, and suppress electromagnetic interference.

In the related art, the windings of inductors or transformers are formed by pressing and bending copper sheets to create the main winding part and the pin part of the windings. The method for preparing the windings limits the miniaturization and production efficiency of inductor devices. For example, in the field of mobile phones, the dimensions of inductor components are often 2.0 mm*1.6 mm*1.0 mm or 1.6 mm*1.0 mm*0.8 mm.

The production method for the miniaturization of inductor components primarily adopts integral molding, with production carried out by pressing one or more inductor components at a time through multiple cavities of a single mold. However, this method for preparing inductor components has a low yield rate (generally about 50%) and low quality stability (resulting in various defective products with defects such as cracking, short circuits, and open circuits) when the width is reduced to below 2 mm, leading to high manufacturing costs.

### SUMMARY

The present invention provides an inductor component and a preparation method thereof to address the problems of oversized inductor components and the low yield rate and quality stability of the production method of integral molding.

In a first aspect, the present invention provides an inductor component, and the inductor component includes at least one conductive structure, a magnetic core, and a covering layer.

Each conductive structure includes a conductive body and two conductive pins. The two conductive pins are spaced apart in a first direction. The first direction is an extension direction of the conductive body. The two conductive pins extend in a second direction and are connected to the conductive body.

The magnetic core is provided with at least two accommodating cavities.

The two conductive pins are respectively inserted into accommodating cavities to connect the each conductive structure to the magnetic core, and the two conductive pins are in a one-to-one correspondence with the accommodating cavities.

The covering layer is disposed on a side of the conductive body of the each conductive structure away from the two conductive pins and is configured to cover the each conductive structure.

In a second aspect, the present invention provides a method for preparing an inductor component, and the method includes the steps below.

A plurality of strip-shaped conductive structures are prepared. Each strip-shaped conductive structure includes a belt-shaped conductive body and a plurality of conductive pins. The plurality of conductive pins are spaced apart in a first direction. The first direction is an extension direction of the belt-shaped conductive body. The plurality of conductive pins extend in a second direction and are connected to the belt-shaped conductive body.

A magnetic core is provided.

A plurality of accommodating cavities are formed in the magnetic core by drilling.

The plurality of conductive pins are inserted into the plurality of accommodating cavities to connect the plurality of strip-shaped conductive structures to the magnetic core, where the plurality of conductive pins are in a one-to-one correspondence with the plurality of accommodating cavities.

A covering layer is formed on a side of the belt-shaped conductive body of the each strip-shaped conductive structure away from the plurality of conductive pins, where the covering layer covers the each conductive structure.

The magnetic core, the plurality of strip-shaped conductive structures, and the covering layer are cut such that a cut magnetic core is connected to at least one conductive structure, and each conductive structure includes a conductive body and two conductive pins.

The present invention provides an inductor component and a preparation method thereof. At least one conductive structure, which includes a conductive body and two conductive pins, is acquired through physical or chemical means. Accommodating cavities are disposed on the magnetic core for the insertion of the conductive pins of the at least one conductive structure of the inductor component, thereby simplifying the structure of the conductive structure and achieving the miniaturization of the inductor component. Moreover, by opening accommodating cavities on the magnetic core, inserting conductive structures, and using cutting methods, multiple inductor components can be mass-produced in a single batch. This not only enables the mass production of inductor components but also greatly improves production efficiency. Furthermore, the consistency of production quality is significantly enhanced, with the yield rate of inductor components reaching over 99.9%. The rate of various types of defective products is sufficiently reduced, application issues are eliminated, and the 6 sigma standard required for applications is met.

### BRIEF DESCRIPTION OF DRAWINGS

To illustrate technical solutions in embodiments of the present invention more clearly, accompanying drawings used in the description of the embodiments are briefly described below. Apparently, the accompanying drawings described below illustrate part of embodiments of the present invention, and those of ordinary skill in the art may acquire other accompanying drawings based on the accompanying drawings described below on the premise that no creative work is done.

FIG. 1 is a diagram illustrating the structures of a conductive structure and a magnetic core according to an embodiment of the present invention.

FIG. 2 is a diagram illustrating the three-dimensional structure of a first inductor component according to an embodiment of the present invention.

FIG. 3 is a sectional view taken along direction A1-A2 of FIG. 2.

FIG. 4 is a diagram illustrating the three-dimensional structure of a second inductor component according to an embodiment of the present invention.

FIG. 5 is a sectional view taken along direction B1-B2 of FIG. 4.

FIG. 6 is a diagram illustrating the three-dimensional structure of a third inductor component according to an embodiment of the present invention.

FIG. 7 is a sectional view taken along direction C1-C2 of FIG. 6.

FIG. 8 is a diagram illustrating the three-dimensional structure of a fourth inductor component according to an embodiment of the present invention.

FIG. 9 is a sectional view taken along direction D1-D2 of FIG. 8.

FIG. 10 is a diagram illustrating the three-dimensional structure of a fifth inductor component according to an embodiment of the present invention.

FIG. 11 is a sectional view taken along direction E1-E2 of FIG. 10.

FIG. 12 is a diagram illustrating the three-dimensional structure of a sixth inductor component according to an embodiment of the present invention.

FIG. 13 is a sectional view taken along direction G1-G2 of FIG. 12.

FIG. 14 is a flowchart of a method for preparing an inductor component according to an embodiment of the present invention.

FIG. 15 is a diagram illustrating a structure of a strip-shaped conductive structure according to an embodiment of the present invention.

FIG. 16 is a diagram illustrating another structure of the strip-shaped conductive structure according to an embodiment of the present invention.

FIG. 17 is a diagram illustrating a first structure of an inductor component before cutting according to an embodiment of the present invention.

FIG. 18 is a sectional view of part of the structure in FIG. 17.

FIG. 19 is a diagram illustrating a second structure of the inductor component before cutting according to an embodiment of the present invention.

FIG. 20 is a diagram illustrating the structure of the inductor component in FIG. 19 showing cutting paths.

FIG. 21 is a diagram illustrating a third structure of the inductor component before cutting according to an embodiment of the present invention.

FIG. 22 is a sectional view of part of the structure in FIG. 21.

FIG. 23 is a diagram illustrating a fourth structure of the inductor component before cutting according to an embodiment of the present invention.

### DETAILED DESCRIPTION

The solutions in embodiments of the present invention are described clearly and completely in conjunction with drawings in the embodiments of the present invention from which the solutions are better understood by those skilled in the art. Apparently, the embodiments described below are part, not all, of the embodiments of the present invention. Based on the embodiments described herein, all other embodiments acquired by those skilled in the art on the premise that no creative work is done are within the scope of the present invention.

It is to be noted that terms such as “first” and “second” in the description, claims, and drawings of the present invention are used to distinguish between similar objects and are not necessarily used to describe a particular order or sequence. It should be understood that the data used in this manner are interchangeable where appropriate so that the embodiments of the present invention described herein may also be implemented in a sequence not illustrated or described herein. Additionally, terms “comprising”, “including”, and any other variations thereof are intended to encompass a non-exclusive inclusion. For example, a process, method, system, product, or device that includes a series of steps or elements not only includes the expressly listed steps or elements but may also include other steps or elements that are not expressly listed or are inherent to such a process, method, product, or device.

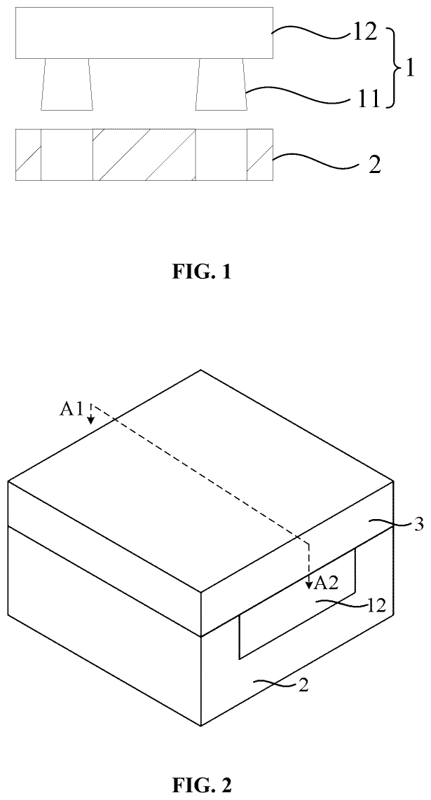

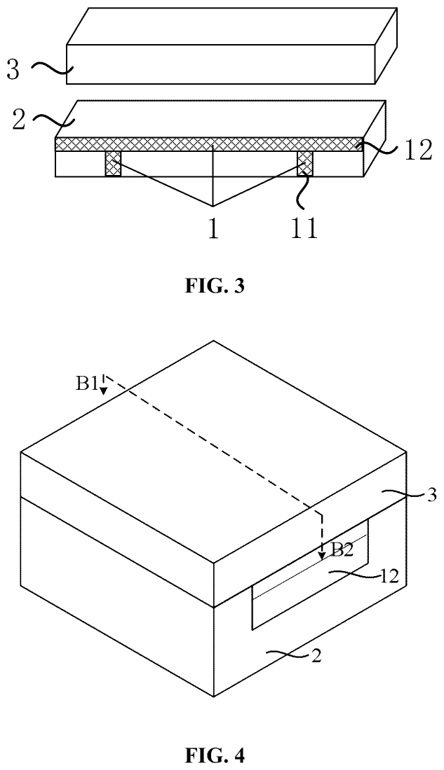

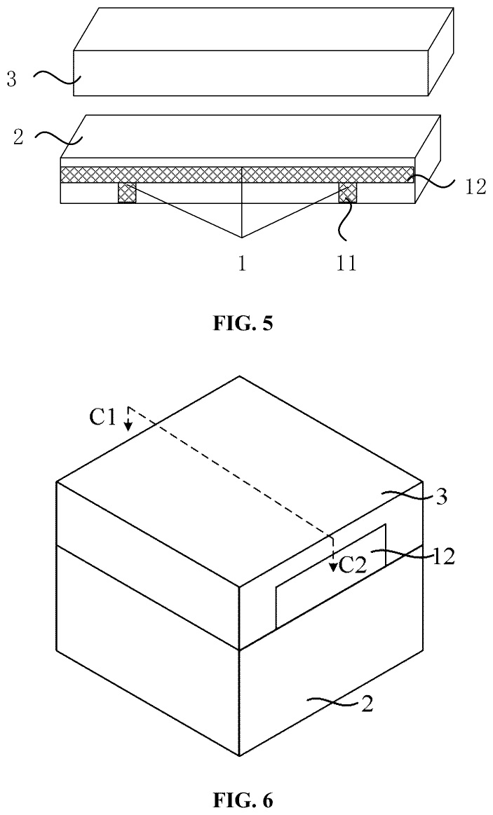

FIG. 1 is a diagram illustrating the structures of a conductive structure and a magnetic core according to an embodiment of the present invention. FIG. 2 is a diagram illustrating the three-dimensional structure of a first inductor component according to an embodiment of the present invention. FIG. 3 is a sectional view taken along direction A1-A2 of FIG. 2. FIG. 4 is a diagram illustrating the three-dimensional structure of a second inductor component according to an embodiment of the present invention. FIG. 5 is a sectional view taken along direction B1-B2 of FIG. 4. FIG. 6 is a diagram illustrating the three-dimensional structure of a third inductor component according to an embodiment of the present invention. FIG. 7 is a sectional view taken along direction C1-C2 of FIG. 6.

As shown in FIG. 1 and FIG. 2 to FIG. 7, the inductor component includes at least one conductive structure 1 and a magnetic core 2; each conductive structure 1 includes a conductive body 12 and two conductive pins 11; the two conductive pins 11 are spaced apart in a first direction 11, and the first direction is an extension direction of the conductive body 12; the two conductive pins 11 extend in a second direction and are connected to the conductive body 12; the magnetic core 2 is provided with at least two accommodating cavities; the two conductive pins 11 are respectively inserted into accommodating cavities to connect the each conductive structure 1 to the magnetic core 2, and the two conductive pins 11 are in a one-to-one correspondence with the accommodating cavities.

As shown in FIG. 2 to FIG. 7, the inductor component also includes a covering layer 3; the covering layer 3 is disposed on a side of the conductive body 12 of the each conductive structure 1 away from the two conductive pins 12 and is configured to cover the each conductive structure 1. Optionally, to enhance the magnetic flux density of the inductor component and thus improve the energy storage effect of the inductor component, the covering layer 3 also covers the magnetic core 2. Optionally, in the embodiment of the present invention, the second direction is arranged perpendicular to the first direction.

In this embodiment, the inductor component is a component capable of converting electrical energy into magnetic energy for storage. The conductive structure 1 is a crucial part of the inductor component and is generally made from conductive materials. The magnetic core 2 is another crucial part of the inductor component and is generally made from magnetic materials. The magnetic core 2 can effectively enhance the performance of the inductor component and improve the operational efficiency and stability of the inductor component. The covering layer 3 primarily serves to cover the conductive structure 1 and prevent the conductive structure 1 from being exposed. The magnetic flux lines formed by the covering layer 3 and the magnetic core 2 are used to enhance the magnetic induction effect, prevent magnetic leakage, and improve the energy storage effect of the inductor component.

Optionally, the conductive structure 1 includes a conductive body 12 and two conductive pins 11. The two conductive pins 11 are spaced apart in the extension direction of the conductive body 12. The extension direction of the conductive body 12 is the first direction. The two conductive pins 11 extend in a direction perpendicular to the extension direction of the conductive body 12, and the direction perpendicular to the extension direction of the conductive body 12 is the second direction. The conductive body 12 is connected to the two conductive pins 11. The conductive structure 1 may be manufactured by physical mechanical processing or chemical processing of a copper strip. Illustratively, the conductive structure 1 may be formed by etching, depositing, or sputtering the copper strip. Illustratively, a conductive pin 11 with a width of 0.1 mm may be formed by etching a copper strip with a width of 0.3 mm and a thickness of 0.2 mm, thereby forming the conductive structure 1.

The material of the magnetic core 2 may include at least one of ferrite, nickel-zinc ferrite, iron-silicon-aluminum, iron-silicon, iron-silicon-chromium, iron-nickel, silicon steel, or cobalt ferrite. In this embodiment, the magnetic core 2 is formed by sintering magnetic powder, without the use of organic binders to effectively increase the density of the magnetic core 2, thus further enhancing the magnetic induction effect. The magnetic core 2 is provided with two accommodating cavities, and the two accommodating cavities may be formed on the magnetic core 2 by mechanical drilling, electrical discharge machining (EDM) drilling, or laser drilling. The two accommodating cavities on the magnetic core 2 are in a one-to-one correspondence with the two conductive pins 11 of the conductive structure 1. The accommodating cavities on the magnetic core 2 are used to accommodate the two conductive pins 11 of the conductive structure 1, that is, the two conductive pins 11 are inserted into the two accommodating cavities, respectively, thereby connecting the conductive structure 1 to the magnetic core 2.

The covering layer 3 is disposed on a side of the conductive body 12 of the conductive structure 1 away from the conductive pins 11. The covering layer 3 may be a magnetic sheet or a resin layer containing magnetic powder.

According to the technical solution of this embodiment, the inductor component includes at least one conductive structure 1, a magnetic core 2, and a covering layer 3. Each conductive structure 1 serves as a single turn of the winding. The number of conductive structures 1 is the number of turns of the winding. A finished inductor component has a length greater than or equal to 0.4 mm and less than or equal to 1.6 mm, a width greater than or equal to 0.4 mm and less than or equal to 1.0 mm, and a height greater than or equal to 0.4 mm and less than or equal to 0.8 mm.

The technical solution of this embodiment provides an inductor component. At least one conductive structure, which includes a conductive body and two conductive pins, is acquired through physical or chemical means. Accommodating cavities are disposed on the magnetic core for the insertion of the conductive pins of the at least one conductive structure of the inductor component, thereby simplifying the structure of the conductive structure and achieving the miniaturization of the inductor component. This inductor component may also be mass-produced, and the production efficiency is greatly improved. Furthermore, the consistency of production quality is significantly enhanced, with the yield rate of inductor components reaching over 99.9%. The rate of various types of defective products is sufficiently reduced, application issues are eliminated, and the 6 sigma standard required for applications is met.

Optionally, as shown in FIG. 2 and FIG. 3, the surface of the magnetic core 2 includes a belt-shaped groove, and the belt-shaped groove communicates with two accommodating cavities; the conductive body 12 is disposed in the belt-shaped groove, and the height of the conductive body 12 is the same as the depth of the belt-shaped groove.

Optionally, as shown in FIGS. 2 and 3, the surface of the magnetic core 2 may be provided with a belt-shaped groove, and two accommodating cavities are disposed in the second direction from the belt-shaped groove of the magnetic core 2, that is, the belt-shaped groove is connected to the two accommodating cavities. The two conductive pins 11 of the conductive structure 1 are inserted into the accommodating cavities, and the conductive body 12 of the conductive structure 1 is accommodated in the belt-shaped groove of the magnetic core 2. Moreover, the height of the conductive body 12 is the same as the depth of the belt-shaped groove of the magnetic core 2, and the conductive body 12 is completely accommodated in the belt-shaped groove.

In other embodiments, the height of the conductive body 12 may be greater or less than the depth of the belt-shaped groove. As shown in FIGS. 4 and 5, the height of the conductive body 12 is less than the depth of the belt-shaped groove.

Alternatively, as shown in FIGS. 6 and 7, the conductive body 12 is disposed on the surface of the magnetic core 2.

As shown in FIGS. 6 and 7, the surface of the magnetic core 2 is not provided with a belt-shaped groove; only two accommodating cavities are disposed in the magnetic core 2 in the second direction. The two conductive pins 11 of the conductive structure 1 are inserted into the accommodating cavities, and the conductive body 12 of the conductive structure 1 is disposed on the surface of the magnetic core 2.

Optionally, as shown in FIG. 2 and FIG. 3, the covering layer 3 includes a magnetic sheet, and the magnetic sheet covers the each conductive structure 1 and the magnetic core 2.

Optionally, as shown in FIG. 2 and FIG. 3, the surface of the magnetic core 2 is provided with a belt-shaped groove, two accommodating cavities are disposed in the second direction from the belt-shaped groove of the magnetic core 2, the two conductive pins 11 of the conductive structure 1 are inserted into the accommodating cavities, and the belt-shaped conductive body 12 of the conductive structure 1 is entirely accommodated in the belt-shaped groove of the magnetic core 2. In this type of structure, the covering layer 3 may be a magnetic sheet placed on the surface of the magnetic core 2 and covering the belt-shaped conductive body 12 of the conductive structure 1 so that the conductive structure 1 of the inductor component is not exposed. The magnetic flux lines formed by the magnetic sheet and the magnetic core 2 are used to enhance the magnetic induction effect, prevent magnetic leakage, and improve the energy storage effect of the inductor component. It should be noted that as shown in FIG. 4 and FIG. 5, the height of the conductive body 12 is less than the depth of the belt-shaped groove. The covering layer 3 includes a magnetic sheet, and the magnetic sheet covers the each conductive structure 1 and the magnetic core 2.

Optionally, as shown in FIG. 6 and FIG. 7, the covering layer 3 includes a resin layer, and the resin layer includes magnetic powder.

Optionally, as shown in FIGS. 6 and 7, the surface of the magnetic core 2 is not provided with a belt-shaped groove; only two accommodating cavities are disposed in the magnetic core 2 in the second direction. The two conductive pins 11 of the conductive structure 1 are inserted into the accommodating cavities, and the conductive body 12 of the conductive structure 1 is disposed on the surface of the magnetic core 2. In this type of structure, the covering layer 3 may be a resin layer containing 5% to 50% magnetic powder, and the covering layer 3 may be hot-pressed onto the surface of the magnetic core 2 to cover the conductive body 12 of the conductive structure 1 so that the conductive structure 1 of the inductor component is not exposed. The magnetic flux lines formed by the resin layer containing magnetic powder and the magnetic core 2 are used to enhance the magnetic induction effect, prevent magnetic leakage, and improve the energy storage effect of the inductor component. It should be noted that in other embodiments, the surface of the magnetic core 2 is provided with a belt-shaped groove, and the height of the conductive body 12 is greater than the depth of the belt-shaped groove. In this structure, the covering layer 3 includes a resin layer containing magnetic powder.

In FIGS. 2 to 7, the shapes and sizes of the conductive pins 11 and the accommodating cavities match the magnetic core. However, to facilitate the installation of the conductive structure 1 and the magnetic core 2, in some embodiments, the sizes and shapes of the conductive pins 11 may be different from those of the accommodating cavities. Optionally, the outer diameter of an accommodating cavity opened in the magnetic core 2 is greater than the outer diameter of a conductive pin 11. That is, the maximum outer diameter of the conductive pin 11 is less than the minimum outer diameter of the accommodating cavity, making it easier to insert the conductive pin 11. For example, when both the conductive pin 11 and the accommodating cavity are circular, the diameter of the accommodating cavity is greater than the diameter of the conductive pin 11; alternatively, when both the conductive pin 11 and the accommodating cavity are quadrilateral, the length and width of the accommodating cavity are greater than the length and width of the conductive pin 11; alternatively, if the cross-section of the conductive pin 11 is quadrilateral and the accommodating cavity is circular, the diameter of the circumscribed circle of the cross-section of the conductive pin 11 is less than the diameter of the accommodating cavity. These examples are not exhaustive.

Further, to ensure that the conductive pin 11, once inserted into the accommodating cavity disposed in the magnetic core 2, does not easily detach, the size of the end portion of the conductive pin 11 away from the conductive body 12 in some other embodiments increases to be the same as the size of the accommodating cavity; alternatively, as shown in FIG. 1, the cross-sectional area of the conductive pin 11 increases gradually in the direction toward the magnetic core 2, and the angle of inclination between the side surface of the conductive pin 11 and the surface adjacent to the magnetic core 2 ranges from 0° to 4°.

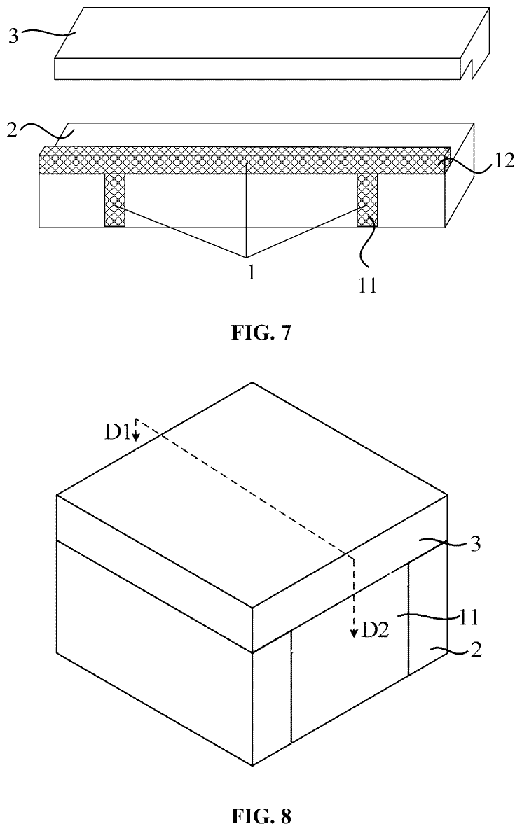

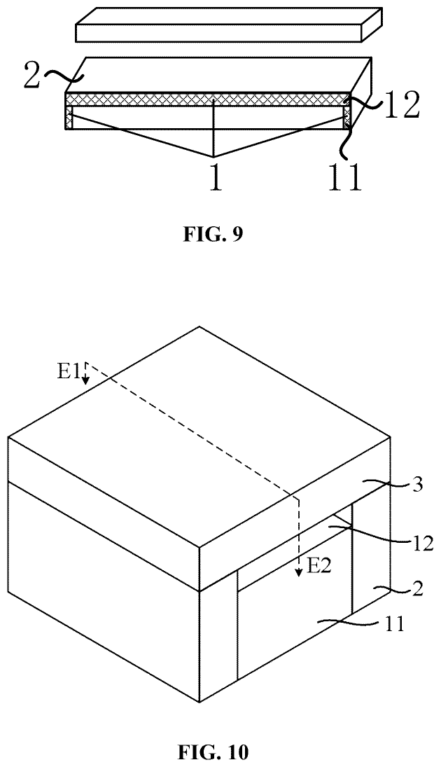

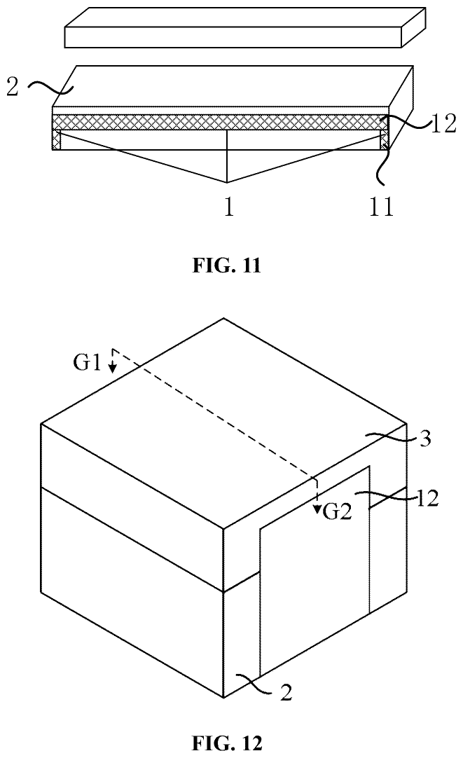

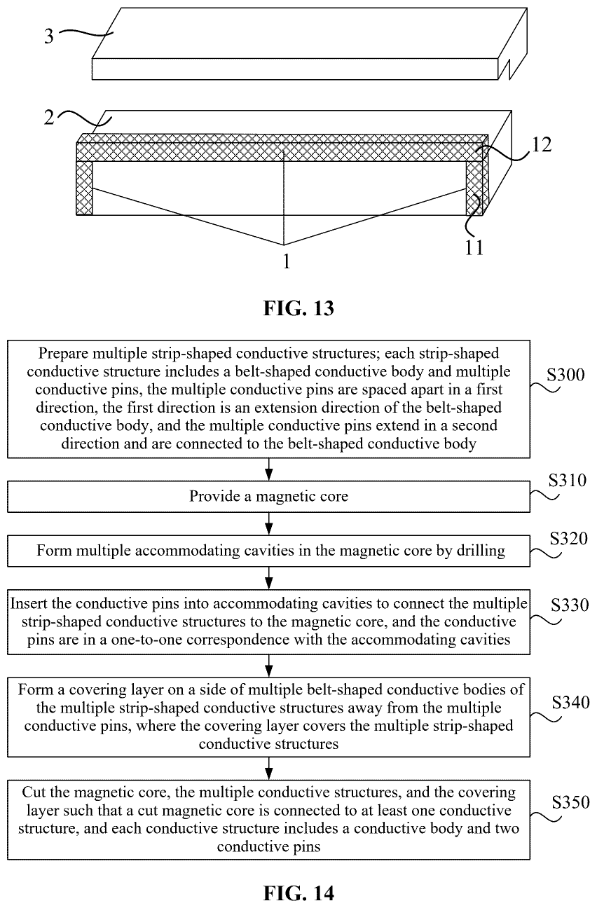

FIG. 8 is a diagram illustrating the three-dimensional structure of a fourth inductor component according to an embodiment of the present invention. FIG. 9 is a sectional view taken along direction D1-D2 of FIG. 8. FIG. 10 is a diagram illustrating the three-dimensional structure of a fifth inductor component according to an embodiment of the present invention. FIG. 11 is a sectional view taken along direction E1-E2 of FIG. 10. FIG. 12 is a diagram illustrating the three-dimensional structure of a sixth inductor component according to an embodiment of the present invention. FIG. 13 is a sectional view taken along direction G1-G2 of FIG. 12.

As shown in FIGS. 8 to 13, the two accommodating cavities on the magnetic core 2 may be disposed on two side surfaces of the magnetic core 2, the two conductive pins 11 of the conductive structure 1 are in a one-to-one correspondence with the two accommodating cavities on the side surfaces of the magnetic core 2, and the two accommodating cavities on the side surfaces of the magnetic core 2 are used to accommodate the two conductive pins 11 of the conductive structure 1, that is, the two conductive pins 11 are inserted into the accommodating cavities on the two side surfaces, respectively, thereby connecting the conductive structure 1 to the magnetic core 2. It should be noted that as shown in FIGS. 8 and 9, the conductive body 12 of the conductive structure 1 is completely accommodated in the belt-shaped groove of the magnetic core 2. The height of the conductive body 12 of the conductive structure 1 is the same as the depth of the belt-shaped groove of the magnetic core 2. In FIGS. 10 and 11, the conductive body 12 of the conductive structure 1 is completely accommodated in the belt-shaped groove of the magnetic core 2. The height of the conductive body 12 of the conductive structure 1 is less than the depth of the belt-shaped groove of the magnetic core 2. In other embodiments, the height of the conductive body 12 of the conductive structure 1 may also be greater than the depth of the belt-shaped groove of the magnetic core 2.

It can be understood that when the external dimensions of inductor components are the same, the distance between the two accommodating cavities disposed on the two opposite side surfaces of the magnetic core 2 is greater than the distance between the two accommodating cavities disposed in the magnetic core 2. Two conductive pins 11 of the conductive structure 1 are in a one-to-one correspondence with two accommodating cavities, that is, the conductive pins 11 occupy less volume of the magnetic core 2, which can lead to higher performance of the inductor components, such as increased inductance. When the performance of inductor components, such as inductance, is the same, the distance between the two accommodating cavities disposed on the two opposite side surfaces of the magnetic core 2 may be equal to the distance between the two accommodating cavities disposed in the magnetic core 2. Two conductive pins 11 of the conductive structure 1 are in a one-to-one correspondence with two accommodating cavities. Therefore, the size of the inductor component with two accommodating cavities disposed on the two opposite side surfaces of the magnetic core 2 can be smaller.

An aspect of the present application also provides a method for preparing an inductor component. As shown in FIG. 14, FIG. 14 is a flowchart of a method for preparing an inductor component according to an embodiment of the present invention. The method includes the steps described below.

In S300, multiple strip-shaped conductive structures are prepared; each strip-shaped conductive structure includes a belt-shaped conductive body and multiple conductive pins, the multiple conductive pins are spaced apart in a first direction, the first direction is an extension direction of the belt-shaped conductive body, and the multiple conductive pins extend in a second direction and are connected to the belt-shaped conductive body.

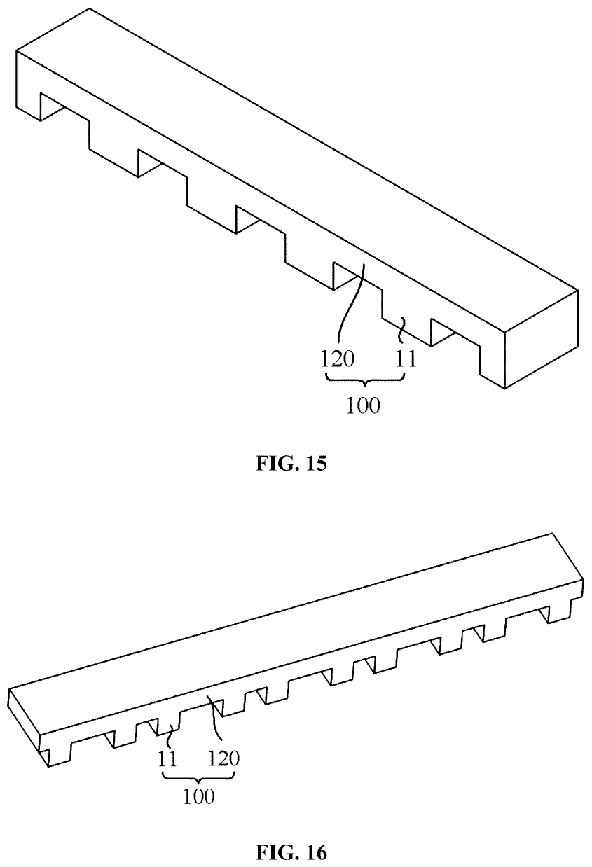

Optionally, FIG. 15 is a diagram illustrating a structure of a strip-shaped conductive structure according to an embodiment of the present invention, and FIG. 16 is a diagram illustrating another structure of the strip-shaped conductive structure according to an embodiment of the present invention.

As shown in FIGS. 15 and 16, the strip-shaped conductive structure 100 includes a belt-shaped conductive body 120 and multiple conductive pins 11. The conductive structure 100 may be manufactured by physical mechanical processing or chemical processing of a copper strip. Illustratively, the conductive structure 100 may be formed by etching, depositing, or sputtering the copper strip. Illustratively, a conductive pin 11 with a width of 0.1 mm may be formed on a copper strip with a width W1 of 0.3 mm and a thickness h of 0.2 mm through etching. Illustratively, the strip-shaped conductive structure 100 may also be formed by first forming a groove on the conductive body through chemical or physical processing and then forming the strip-shaped conductive structure 100 shown in FIG. 15 or FIG. 16 through chemical or physical processing.

The strip-shaped conductive structure 100 shown in FIG. 15 may be formed using a conductive metal, a conductive alloy, or a mixture containing the conductive metal. This strip-shaped conductive structure 100 includes multiple grooves and multiple conductive pins 11 that are arranged at intervals, and the grooves and the conductive pins 11 are adjacent and arranged alternately. The widths of the multiple grooves of the strip-shaped conductive structure 100 are equal. The side end faces of the conductive pins 11 at two ends of the strip-shaped conductive structure 100 are flush with the side end faces of the belt-shaped conductive body 120 of the strip-shaped conductive structure 100, and the width of each conductive pin 11 at two ends of a first strip-shaped conductive structure is half the width of each conductive pin 11 in the middle of the strip-shaped conductive structure 100. After the strip-shaped conductive structure 100 is processed in conjunction with the magnetic core 2, the conductive pins 11 are disposed in the magnetic core 2 of each inductor component. By cutting from the conductive pins 11, a conductive structure 1 including the belt-shaped conductive body 120 and two conductive pins 11, as shown in FIGS. 8 to 13, can be obtained.

The strip-shaped conductive structure 100 shown in FIG. 16 may be formed using a conductive metal, a conductive alloy, or a mixture containing the conductive metal. This strip-shaped conductive structure 100 includes multiple grooves and multiple conductive pins 11 that are arranged at intervals, and the grooves and the conductive pins 11 are adjacent and arranged alternately. In FIG. 16, the widths of the multiple conductive pins 11 of the strip-shaped conductive structure 100 are equal, and the conductive pins 11 at two ends of the strip-shaped conductive structure 100 form a step with the side end faces of the belt-shaped conductive body 120 of the strip-shaped conductive structure 100. The grooves include a first slot and a second slot, where the width of the first groove is greater than that of the second groove. Of course, in other embodiments, the widths of the first groove and the second groove may also be equal, and the specific configuration may be adjusted according to actual production requirements. By cutting from the second groove, a conductive structure 1 including the belt-shaped conductive body 12 and two conductive pins 11, as shown in FIG. 1 and FIGS. 2 to 7, can be obtained.

In S310, a magnetic core is provided.

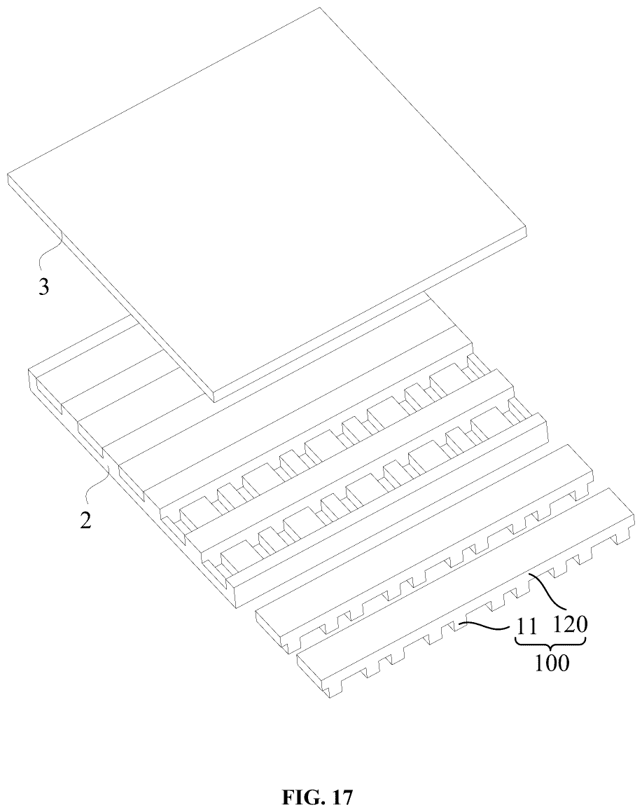

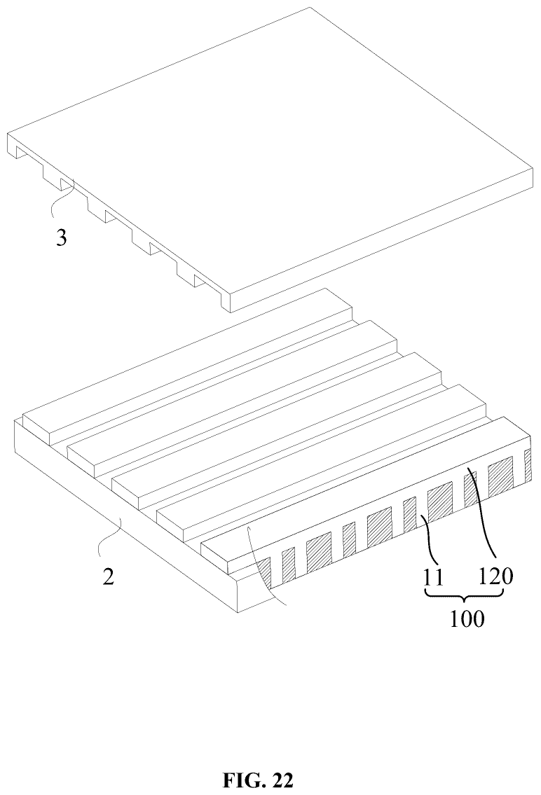

Optionally, with reference to FIGS. 17 to 23, a magnetic core 2 is provided. The material of the magnetic core 2 may include at least one of ferrite, nickel-zinc ferrite, cobalt ferrite, iron-silicon-aluminum, iron-silicon, iron-silicon-chromium, iron-nickel, or silicon steel. In this embodiment, the magnetic core 2 is formed by sintering magnetic powder, without the use of organic binders to effectively increase the density of the magnetic core 2, thus further enhancing the magnetic induction effect.

In S320, multiple accommodating cavities are formed in the magnetic core by drilling.

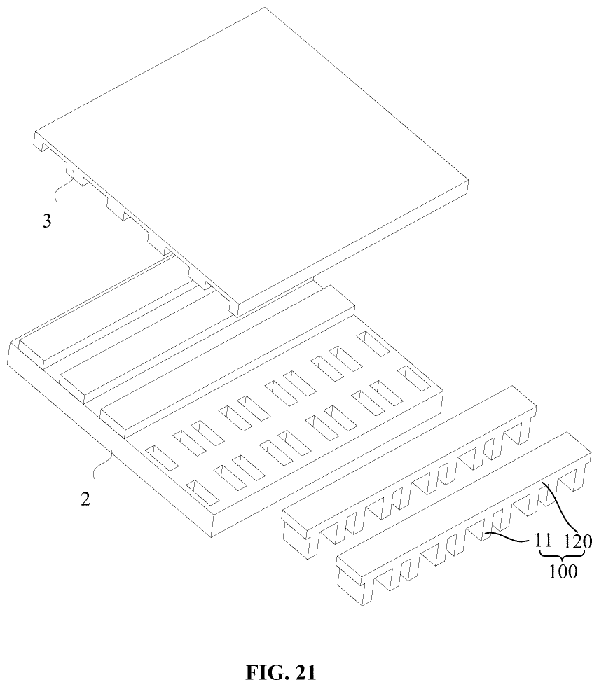

Optionally, in FIGS. 21 to 23, the magnetic core 2 is not provided with a belt-shaped groove for accommodating the belt-shaped conductive body 120. In FIGS. 17 to 20, the magnetic core 2 is provided with a belt-shaped groove for accommodating the belt-shaped conductive body 120. With reference to FIGS. 17 to 23, the magnetic core 2 is provided with multiple accommodating cavities, and the multiple accommodating cavities may be formed on the magnetic core 2 by mechanical drilling, electrical discharge machining drilling, or laser drilling. The multiple accommodating cavities on the magnetic core 2 are in a one-to-one correspondence with the multiple conductive pins 11 of the conductive structure.

In S330, the conductive pins are inserted into accommodating cavities to connect the multiple strip-shaped conductive structures and the magnetic core, and the conductive pins are in a one-to-one correspondence with the accommodating cavities.

Optionally, as shown in FIG. 17 to FIG. 23, the conductive pins 11 are respectively inserted into accommodating cavities to connect the multiple conductive structures 100 to the magnetic core 2, and the conductive pins 11 are in a one-to-one correspondence with the accommodating cavities.

In S340, a covering layer is formed on a side of multiple belt-shaped conductive bodies of the multiple strip-shaped conductive structures away from the multiple conductive pins, where the covering layer covers the multiple strip-shaped conductive structures.

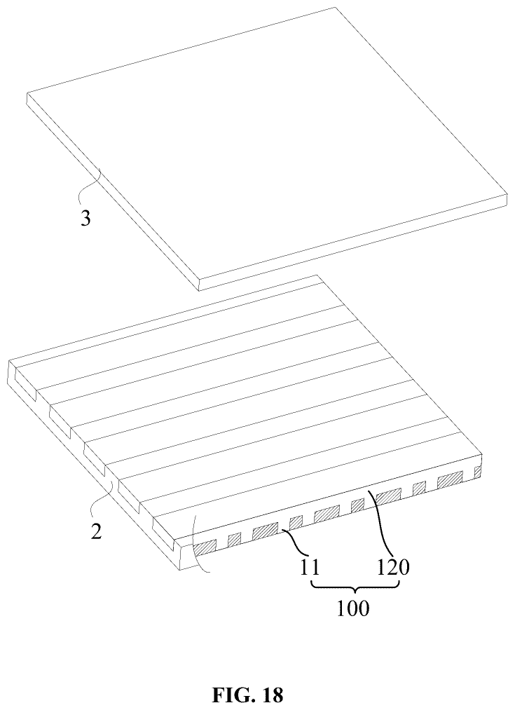

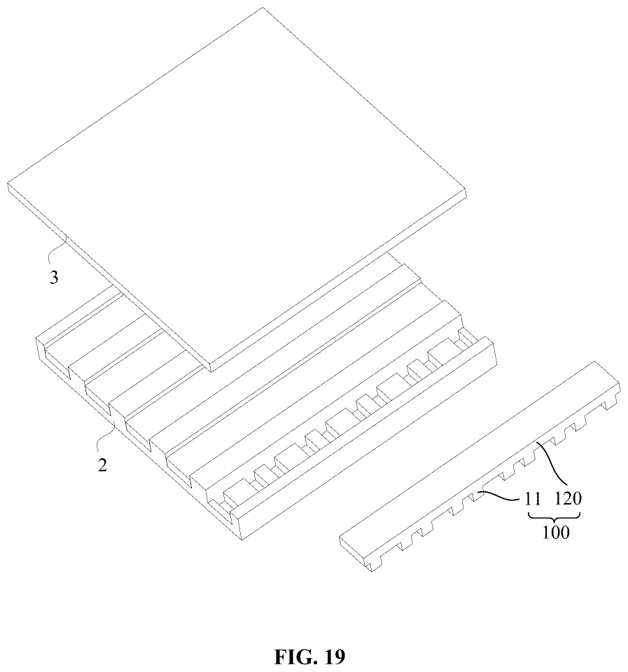

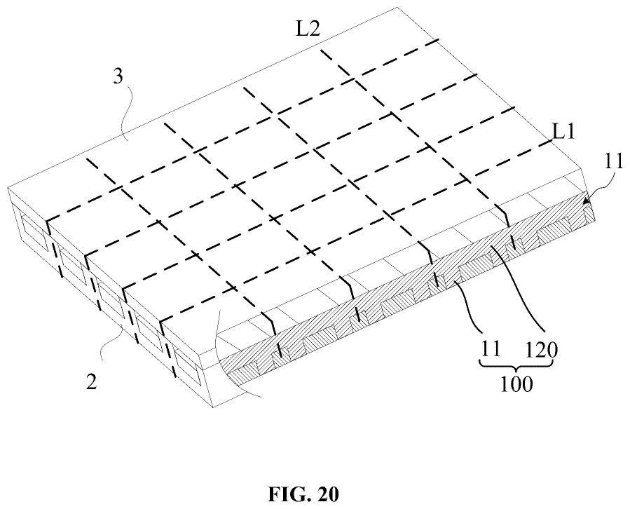

As shown in FIGS. 17 to 23, the covering layer 3 is disposed on the side of the belt-shaped conductive bodies 120 of the strip-shaped conductive structures 100 away from the conductive pins 11. The covering layer 3 may be a magnetic sheet or a resin containing magnetic powder. The covering layer 3 is disposed on the surface of the magnetic core 2, covering the belt-shaped conductive bodies 120 of the strip-shaped conductive structures 100 so that the conductive structure of the inductor component is not exposed. The magnetic flux lines formed by the covering layer 3 and the magnetic core 2 are used to enhance the magnetic induction effect, prevent magnetic leakage, and improve the energy storage effect of the inductor component. In FIGS. 17 and 18, the surface of the magnetic core 2 is provided with a belt-shaped groove, and the height of the belt-shaped conductive body 120 is equal to the depth in the belt-shaped groove. As shown in FIGS. 19 and 20, the height of the belt-shaped conductive body 120 is less than the depth of the belt-shaped groove. In the preceding structures, the belt-shaped conductive body 120 is disposed in the belt-shaped groove, and the conductive pins 11 are inserted in the accommodating cavities to connect the strip-shaped conductive structure 100 to the magnetic core 2. The covering layer 3 is a magnetic sheet. In other embodiments, the height of the belt-shaped conductive body 120 may be greater than the depth of the belt-shaped groove, and the covering layer 3 is a resin containing magnetic powder. As shown in FIGS. 21, 22, and 23, the surface of the magnetic core 2 is not provided with a belt-shaped groove, and the covering layer 3 is a resin layer containing magnetic powder.

In S350, the magnetic core, the multiple conductive structures, and the covering layer are cut such that a cut magnetic core is connected to at least one conductive structure, and each conductive structure includes a conductive body and two conductive pins.

As shown in FIGS. 16 and 20, by cutting from the second groove, a conductive structure 1 including the conductive body 12 and two conductive pins 11, as shown in FIG. 1 and FIGS. 2 to 7, can be obtained.

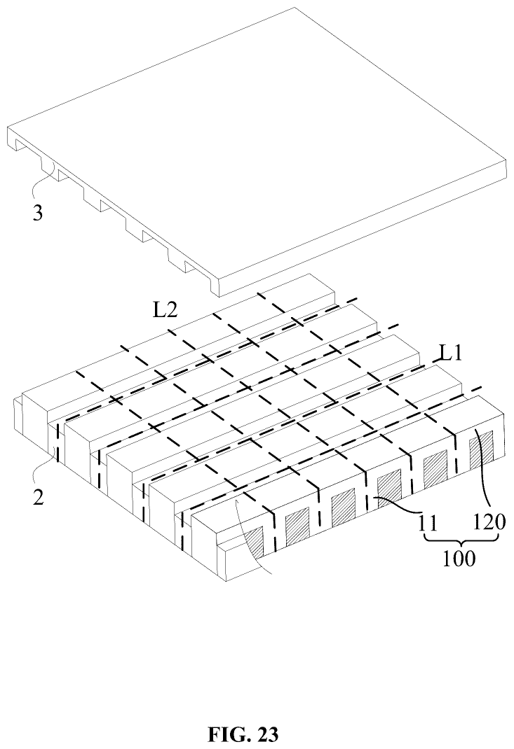

As shown in FIGS. 15 and 23, by cutting from the conductive pins 11, a conductive structure 1 including the conductive body 12 and two conductive pins 11, as shown in FIGS. 8 to 13, can be obtained.

Optionally, based on the preceding technical solution, S350 where the magnetic core, the multiple strip-shaped conductive structures, and the covering layer are cut such that the cut magnetic core is connected to the at least one conductive structure and the each conductive structure includes the conductive body and the two conductive pins includes the following: cutting the magnetic core, the multiple strip-shaped conductive structures, and the covering layer along a first cutting path and a second cutting path such that the cut magnetic core is connected to the at least one conductive structure, and the each conductive structure includes the conductive body and the two conductive pins, where the first cutting path and the second cutting path intersect.

As shown in FIG. 20, the cutting path includes a first cutting path L1 and a second cutting path L2 that intersect. By cutting from the first cutting path L1 and the second cutting path L2, a conductive structure 1 including the conductive body 12 and two conductive pins 11, as shown in FIG. 1 and FIGS. 2 to 7, can be obtained.

As shown in FIG. 23, the cutting path includes a first cutting path L1 and a second cutting path L2 that intersect. By cutting from the first cutting path L1 and the second cutting path L2, a conductive structure 1 including the conductive body 12 and two conductive pins 11, as shown in FIGS. 8 to 13, can be obtained.

It should be noted that after cutting in the preceding FIGS. 20 and 23, each inductor component includes only one conductive structure 1, but in other embodiments, after cutting, each inductor component may include at least two conductive structures 1 arranged at intervals to form a collective inductor.

The technical solution of this embodiment provides a method for preparing an inductor component. At least one conductive structure, which includes a conductive body and two conductive pins, is acquired through physical or chemical means. Accommodating cavities are disposed on the magnetic core for the insertion of the conductive pins of the at least one conductive structure of the inductor component, thereby simplifying the structure of the conductive structure and achieving the miniaturization of the inductor component. The magnetic core, the multiple strip-shaped conductive structures, and the covering layer are cut along a first cutting path and a second cutting path such that a cut magnetic core is connected to at least one conductive structure, and each conductive structure includes a conductive body and two conductive pins. With the preceding technical solution, the inductor component can be mass-produced, and the production efficiency is greatly improved. Furthermore, the consistency of production quality is significantly enhanced, with the yield rate of inductor components reaching over 99.9%. The rate of various types of defective products is sufficiently reduced, application issues are eliminated, and the 6 sigma standard required for applications is met.

Optionally, S330 where the conductive pins are inserted into the accommodating cavities to connect the multiple strip-shaped conductive structures to the magnetic core includes the following:

As shown in FIGS. 17 and 18, multiple belt-shaped grooves are formed on the surface of the magnetic core 2, where the multiple belt-shaped grooves communicate with the multiple accommodating cavities, the heights of the multiple belt-shaped conductive bodies 120 match the depths of the multiple belt-shaped grooves, and the multiple belt-shaped conductive bodies 120 are in a one-to-one correspondence with the multiple belt-shaped grooves.

As shown in FIGS. 17 and 18, the conductive pins are inserted into the accommodating cavities.

As shown in FIGS. 17 and 18, the belt-shaped conductive bodies 120 are placed into the belt-shaped grooves to connect the multiple strip-shaped conductive structures 100 to the magnetic core 2.

As shown in FIGS. 17 and 18, the surface of the magnetic core 2 may be provided with belt-shaped grooves, and multiple accommodating cavities are disposed in the second direction from the belt-shaped grooves of the magnetic core 2, that is, the belt-shaped grooves are connected to the multiple accommodating cavities. The multiple conductive pins 11 of a strip-shaped conductive structure 100 are inserted into the accommodating cavities, and the conductive body 120 of the strip-shaped conductive structure 100 is accommodated in a belt-shaped groove of the magnetic core 2. Moreover, the height of the belt-shaped conductive body 120 is the same as the depth of the belt-shaped groove of the magnetic core 2, and the belt-shaped conductive body 120 is completely accommodated in the belt-shaped groove. Optionally, as shown in FIGS. 19 and 20, the height of a belt-shaped conductive body 120 is less than the depth of a belt-shaped groove. In other embodiments, the height of a belt-shaped conductive body 120 may also be greater than the depth of a belt-shaped groove.

Alternatively, S330 where the conductive pins are inserted into the accommodating cavities to connect the multiple strip-shaped conductive structures to the magnetic core includes the following:

As shown in FIGS. 21 to 23, belt-shaped conductive bodies 120 are disposed on the surface of the magnetic core 2.

The conductive pins 11 are inserted into accommodating cavities to connect the multiple strip-shaped conductive structures 100 to the magnetic core 2.

Optionally, the surface of the magnetic core 2 is not provided with a belt-shaped groove; only multiple accommodating cavities are disposed in the magnetic core 2 in the second direction. Multiple conductive pins 11 of the strip-shaped conductive structures 100 are inserted into the accommodating cavities, and the belt-shaped conductive bodies 120 of the conductive structures 100 are disposed on the surface of the magnetic core 2.

Optionally, the covering layer 3 includes a magnetic sheet, and S340 where the covering layer is formed on the side of the multiple belt-shaped conductive bodies of the multiple strip-shaped conductive structures away from the multiple conductive pins includes the following:

A magnetic sheet is formed on a side of multiple belt-shaped conductive bodies of the multiple strip-shaped conductive structures away from the multiple conductive pins, where the magnetic sheet covers the strip-shaped conductive structures.

Optionally, as shown in FIG. 17 to FIG. 20, the surface of the magnetic core 2 is provided with belt-shaped grooves, multiple accommodating cavities are disposed in the second direction from the belt-shaped grooves of the magnetic core 2, the multiple conductive pins 11 of the strip-shaped conductive structures 100 are inserted into the accommodating cavities, and the belt-shaped conductive bodies 120 of the conductive structures 100 are entirely accommodated in the belt-shaped grooves of the magnetic core 2. In this type of structure, the covering layer 3 may be a magnetic sheet placed on the surface of the magnetic core 2 and covering the belt-shaped conductive bodies 120 of the strip-shaped conductive structures 100 so that the conductive structure of the inductor component is not exposed. The magnetic flux lines formed by the magnetic sheet and the magnetic core 2 are used to enhance the magnetic induction effect, prevent magnetic leakage, and improve the energy storage effect of the inductor component.

Optionally, the covering layer 3 includes a magnetic sheet, and S340 where the covering layer is formed on the side of the multiple belt-shaped conductive bodies of the multiple strip-shaped conductive structures away from the multiple conductive pins includes the following:

A resin layer is formed on the side of the multiple belt-shaped conductive bodies of the multiple strip-shaped conductive structures away from the multiple conductive pins by a hot pressing process, where the resin layer includes magnetic powder.

Optionally, as shown in FIGS. 21 to 23, the surface of the magnetic core 2 is not provided with a belt-shaped groove; only multiple accommodating cavities are disposed in the magnetic core 2 in the second direction. Multiple conductive pins 11 of the strip-shaped conductive structures 100 are inserted into the accommodating cavities, and the belt-shaped conductive bodies 120 of the conductive structures 100 are disposed on the surface of the magnetic core 2. In this type of structure, the covering layer 3 may be a resin layer containing 5% to 50% magnetic powder, and the covering layer 3 may be hot-pressed onto the surface of the magnetic core 2 to cover the belt-shaped conductive bodies 120 of the strip-shaped conductive structures 100 so that the strip-shaped conductive structure 100 of the inductor component is not exposed. The magnetic flux lines formed by the resin layer containing magnetic powder and the magnetic core 2 are used to enhance the magnetic induction effect, prevent magnetic leakage, and improve the energy storage effect of the inductor component.

Optionally, S300 where multiple strip-shaped conductive structures are prepared includes the following:

A conductive block is formed. The conductive block is patterned using a wet etching process to form multiple strip-shaped conductive structures, where each strip-shaped conductive structure includes a belt-shaped conductive body and multiple conductive pins, the multiple conductive pins are spaced apart in the first direction, the first direction is the extension direction of the belt-shaped conductive body, and the multiple conductive pins extend in the second direction and are connected to the belt-shaped conductive body.

In this embodiment, wet etching is an etching method that involves immersing the material to be etched in a corrosive solution for etching.

Optionally, a conductive block is provided, and the conductive block may be a copper conductive block. A masking layer may first be applied to the surface of the conductive block, and then a photolithography process is used to create openings in the masking layer in the areas of the conductive block that require wet etching. The preceding conductive block is then placed in a corrosive solution for etching, thereby forming multiple strip-shaped conductive structures 100. Each strip-shaped conductive structure 100 includes a belt-shaped conductive body 120 and multiple conductive pins 11. The multiple conductive pins 11 are arranged at intervals in the extension direction of the belt-shaped conductive body 120. The extension direction of the belt-shaped conductive body 120 is the first direction. These conductive pins extend in a direction perpendicular to the extension direction of the belt-shaped conductive body 120, and the direction perpendicular to the extension direction of the belt-shaped conductive body 120 is the second direction. The belt-shaped conductive body 120 is connected to the two conductive pins 11.

### Alternatively:

A conductive block is provided.

The conductive block is cut into multiple belt-shaped conductive bodies.

Multiple conductive pins are formed on the surface of each belt-shaped conductive body by electroplating or sputtering, where the multiple conductive pins are spaced apart in the first direction, the first direction is the extension direction of each belt-shaped conductive body, and the multiple conductive pins extend in the second direction.

In this embodiment, electroplating is a process that uses the principle of electrolysis to plate a layer of metal onto the surface of certain metals. Sputtering is a process that can deposit metal, alloy, or electrolyte thin films on the surface of a substrate. Sputtering may be divided into direct current sputtering, alternating current sputtering, reactive sputtering, and magnetron sputtering.

Optionally, multiple belt-shaped conductive bodies 120 are formed, and the material of the belt-shaped conductive bodies 120 may be copper. Multiple conductive pins 11 are formed on the surface of each belt-shaped conductive body 120 through electroplating or sputtering. The material of the conductive pins 11 may also be copper. The multiple conductive pins 11 are arranged at intervals in the extension direction of the belt-shaped conductive bodies 120, and the extension direction of the belt-shaped conductive bodies 120 is the first direction. These conductive pins extend in a direction perpendicular to the extension direction of the belt-shaped conductive body 120, and the direction perpendicular to the extension direction of the belt-shaped conductive body 120 is the second direction. The belt-shaped conductive body 120 is connected to the two conductive pins 11.

Optionally, based on the preceding technical solution and as shown in FIG. 20, the cutting path includes a first cutting path L1 and a second cutting path L2 that intersect. By cutting from the first cutting path L1 and the second cutting path L2, a conductive structure 1 including a conductive body 12 and two conductive pins 11, as shown in FIG. 1 and FIGS. 2 to 7, can be obtained. The second cutting path L2 is disposed between two conductive pins 11. The first cutting path L1 is disposed between two strip-shaped conductive structures 100.

As shown in FIG. 23, the cutting path includes a first cutting path L1 and a second cutting path L2 that intersect. By cutting from the first cutting path L1 and the second cutting path L2, a conductive structure 1 including a belt-shaped conductive body 120 and two conductive pins 11, as shown in FIGS. 8 to 13, can be obtained. The second cutting path L2 is disposed in the middle of a single conductive pin 11. The first cutting path L1 is disposed between two strip-shaped conductive structures 100.

It is to be understood that various forms of processes shown above may be adopted with steps reordered, added, or deleted. For example, the steps described in the present invention may be performed in parallel, sequentially, or in different orders, as long as the desired results of the technical solutions of the present invention can be achieved, and no limitation is imposed herein.

What is claimed is:

1. An inductor component, comprising:
at least one conductive structure, wherein each conductive structure of the at least one conductive structure comprises a conductive body and two conductive pins, wherein the two conductive pins are spaced apart in a first direction, the first direction is an extension direction of the conductive body, and the two conductive pins extend in a second direction and are connected to the conductive body;
a magnetic core provided with at least two accommodating cavities, wherein the two conductive pins are respectively inserted into accommodating cavities of the at least two accommodating cavities to connect the each conductive structure to the magnetic core, and the two conductive pins are in a one-to-one correspondence with the accommodating cavities; and
a covering layer disposed on a side of the conductive body of the each conductive structure away from the two conductive pins and configured to cover the each conductive structure.

2. The inductor component of claim 1, wherein a surface of the magnetic core comprises a belt-shaped groove, and the belt-shaped groove communicates with two accommodating cavities of the at least two accommodating cavities;
wherein the conductive body is disposed in the belt-shaped groove, wherein a height of the conductive body is identical to a depth of the belt-shaped groove.

3. The inductor component of claim 1, wherein the conductive body is disposed on the surface of the magnetic core.

4. The inductor component of claim 2, wherein the covering layer comprises a magnetic sheet, and the magnetic sheet covers the each conductive structure.

5. The inductor component of claim 2, wherein the covering layer comprises a resin layer, wherein the resin layer comprises magnetic powder and covers the each conductive structure.

6. The inductor component of claim 4, wherein the covering layer comprises a resin layer, wherein the resin layer comprises magnetic powder and covers the each conductive structure.

7. The inductor component of claim 3, wherein the covering layer comprises a magnetic sheet, and the magnetic sheet covers the each conductive structure.

8. The inductor component of claim 3, wherein the covering layer comprises a resin layer, wherein the resin layer comprises magnetic powder and covers the each conductive structure.

9. The inductor component of claim 7, wherein the covering layer comprises a resin layer, wherein the resin layer comprises magnetic powder and covers the each conductive structure.

10. A method for manufacturing an inductor component, comprising:
preparing a plurality of strip-shaped conductive structures, wherein each strip-shaped conductive structure of the plurality of strip-shaped conductive structures comprises a belt-shaped conductive body and a plurality of conductive pins, the plurality of conductive pins are spaced apart in a first direction, the first direction is an extension direction of the belt-shaped conductive body, and the plurality of conductive pins extend in a second direction and are connected to the belt-shaped conductive body;
providing a magnetic core;
forming a plurality of accommodating cavities in the magnetic core by drilling;
inserting the plurality of conductive pins into the plurality of accommodating cavities to connect the plurality of strip-shaped conductive structures to the magnetic core, wherein the plurality of conductive pins are in a one-to-one correspondence with the plurality of accommodating cavities;
forming a covering layer on a side of the belt-shaped conductive body of the each strip-shaped conductive structure away from the plurality of conductive pins, wherein the covering layer covers the each conductive structure; and
cutting the magnetic core, the plurality of strip-shaped conductive structures, and the covering layer such that a cut magnetic core is connected to at least one conductive structure, and each conductive structure of the at least one conductive structure comprises a conductive body and two conductive pins.

11. The method for manufacturing the inductor component of claim 10, wherein cutting the magnetic core, the plurality of strip-shaped conductive structures, and the covering layer such that the cut magnetic core is connected to the at least one conductive structure and the each conductive structure of the at least one conductive structure comprises the conductive body and the two conductive pins comprises:
cutting the magnetic core, the plurality of strip-shaped conductive structures, and the covering layer along a first cutting path and a second cutting path such that the cut magnetic core is connected to the at least one conductive structure, and the each conductive structure of the at least one conductive structure comprises the conductive body and the two conductive pins, wherein the first cutting path and the second cutting path intersect.

12. The method for manufacturing the inductor component of claim 10, wherein inserting the plurality of conductive pins into the plurality of accommodating cavities to connect the plurality of strip-shaped conductive structures to the magnetic core comprises:
forming a plurality of belt-shaped grooves on a surface of the magnetic core, wherein the plurality of belt-shaped grooves communicate with the plurality of accommodating cavities, heights of the plurality of belt-shaped conductive bodies match depths of the plurality of belt-shaped grooves, and the plurality of belt-shaped conductive bodies are in a one-to-one correspondence with the plurality of belt-shaped grooves;
inserting the plurality of conductive pins into the plurality of accommodating cavities; and
placing the plurality of belt-shaped conductive bodies into the plurality of belt-shaped grooves to connect the plurality of strip-shaped conductive structures to the magnetic core.

13. The method for manufacturing the inductor component of claim 10, wherein inserting the plurality of conductive pins into the plurality of accommodating cavities to connect the plurality of strip-shaped conductive structures to the magnetic core comprises:
positioning the plurality of belt-shaped conductive bodies on the surface of the magnetic core; and
inserting the plurality of conductive pins into the plurality of accommodating cavities to connect the plurality of strip-shaped conductive structures to the magnetic core.

14. The method for manufacturing the inductor component of claim 10, wherein the covering layer comprises a magnetic sheet, and forming the covering layer on the belt-shaped conductive body of the each strip-shaped conductive structure away from the plurality of conductive pins comprises:
forming the magnetic sheet on a side of the belt-shaped conductive body of the each strip-shaped conductive structure away from the magnetic core, wherein the magnetic sheet covers the plurality of strip-shaped conductive structures.

14. The method for manufacturing the inductor component of claim 10, wherein the covering layer comprises a resin layer, and forming the covering layer on the side of the belt-shaped conductive body of the each strip-shaped conductive structure away from the plurality of conductive pins comprises:
forming the resin layer on the side of the plurality of belt-shaped conductive bodies of the plurality of strip-shaped conductive structures away from the plurality of conductive pins by a hot pressing process, wherein the resin layer comprises magnetic powder.

15. The method for manufacturing the inductor component of claim 10, wherein preparing the plurality of strip-shaped conductive structures comprises:
providing a conductive block; and
patterning the conductive block using a wet etching process to form the plurality of strip-shaped conductive structures.

16. The method for manufacturing the inductor component of claim 10, wherein preparing the plurality of strip-shaped conductive structures comprises:
providing a conductive block;
cutting the conductive block into the plurality of belt-shaped conductive bodies; and
forming the plurality of conductive pins on a surface of each belt-shaped conductive body of the plurality of belt-shaped conductive bodies by electroplating or sputtering.

17. The method for manufacturing the inductor component of claim 11, wherein the first cutting path is disposed between two conductive pins of the plurality of conductive pins, or the first cutting path is disposed in a middle of a single conductive pin of the plurality of conductive pins; and
the second cutting path is disposed between two strip-shaped conductive structures of the plurality of strip-shaped conductive structures.
